(19) United States
(12) Patent Application Publication
(10) Pub. No.: US 2007/0094152 A1
(43) Pub. Date: Apr. 26, 2007

(54) Secure electronic transaction authentication enhanced with RFID

(76) Inventors: Brian D. Bauman, Austin, TX (US); Amanda J. Burton, Austin, TX (US); Michael Pierre Carlson, Austin, TX (US); Herman Rodriguez, Austin, TX (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/255,199

(22) Filed: Oct. 20, 2005

(51) Int. Cl. H04L 9/00

(52) U.S. Cl. 705/67

(57) ABSTRACT

Methods, computer program products and systems for authenticating an electronic transaction conducted over an electronic communications link with a user device of a transaction authorizer. A method includes establishing the electronic communications link with the user device of the authorizer, receiving an authentication code from an authorizer RFID over the electronic communication link, and determining if the received authentication code matches a stored authentication code assigned to the authorizer. The electronic transaction may proceed if the stored authentication code matches the received authentication code. Also included may be the step of determining if one or more required personal attributes match stored personal attributes associated with the stored authentication code assigned to the authorizer. If so, then the method may include proceeding with the electronic transaction if the one or more required personal attributes match the stored personal attributes associated with the stored authentication code assigned to the authorizer.

### BACKGROUND OF THE INVENTION

1. Field of the Invention

This invention relates to data processing and more particularly to authentication of electronic transactions.

2. Description of the Related Art

On-line shopping is quickly becoming the preferred means for obtaining consumer products and services. More consumers, for example, are now using the Internet to browse, comparison shop and order products on-line. On-line shopping systems have made product information, including pricing and availability, readily available to consumers and have facilitated the location and purchasing of desired products at lower cost and with added convenience. Likewise, businesses are making use of the on-line availability of goods and service and making purchases from each other over the Internet.

One advantage that consumers and businesses perceive in electronic transactions is the speed with which a transaction may be completed thanks in large part to the use of credit cards, debit cards, direct debiting of bank accounts and the like. However, a drawback to the increased use of these devices, when used without a face-to-face encounter, is the increased risk of fraud. For example, when a purchase is made at a point-of-sale, the merchant can see the card and knows that the user, even if not authorized to use the card, at least has possession of the card. The merchant also receives approval of the charge from the card-issuing entity during the purchase process so the merchant knows the card has not been reported as stolen. However, during an on-line purchase, the merchant does not see the card and does not know whether the purchaser is in possession of the card. Copying a credit card number and using that credit card number in an Internet transaction is an easy form of fraud.

The threat of fraud is a well known problem for those conducting business over the Internet. Methods and devices for authenticating a credit card are much sought after by businesses to protect themselves against fraud. However, in spite of on-going efforts, fraud still remains a major concern for those conducting business over the Internet. For example, how does one party know that the other party to an electronic transaction is who they claim to be?

Therefore, there is a need to increase the level of confidence between parties to an electronic transaction that each of the parties is who or what each claims to be.

### SUMMARY OF THE INVENTION

Embodiments of the present invention include methods, computer program products and systems for authenticating an electronic transaction that is conducted over an electronic communications link with a user device of a transaction authorizer. The authorizer is a party to the electronic transaction that provides authorization for the transaction to proceed, such as a consumer purchasing goods from a business over the Internet. Therefore, the user device of the transaction authorizer is a device that is in the possession and control of the authorizer and is not, for example, in the possession and control of any of the other parties to the electronic transaction or a merchant at a point of sale, such as a store. The user device may be selected from, for example, a telephone, a personal computer, a personal digital assistant, a laptop computer, other suitable communications device or combinations thereof.

In particular embodiments of the present invention, the electronic communications link may be established over an intranet, the Internet, a wide area network, a local area network, a telephone network, other suitable communication networks or combinations thereof.

The electronic transaction may be, for example, a business transaction that includes, for example, the purchase of goods or services or the transaction may be a confidential information transfer transaction or combinations thereof.

Particular embodiments of the present invention may include establishing the electronic communications link with the user device of the authorizer and receiving authorization to proceed with the electronic transaction from the authorizer user device. The authorization to proceed may include, for example, a simple statement from the authorizer that authorizes the electronic transaction, provision of a credit card or debit card number and other suitable forms of authorization.

The method may further include receiving an authentication code from an authorizer RFID over the electronic communication link. If it is determined that the received authentication code matches a stored authentication code assigned to the authorizer, then the electronic transaction may proceed. In particular embodiments, the authentication code may be encrypted so the method may further include decrypting the authentication code received from the authorizer RFID.

In particular embodiments, the step of determining if the received authentication code matches a stored authentication code may further include establishing an electronic communications link with a third party authenticator, sending the received authentication code and an identity parameter of the authorizer to the third party authenticator, and receiving confirmation from the third party authenticator that the received authentication code matches the stored authentication code associated with the authorizer.

In addition to determining whether the authentication code of the authorizer matches the stored authentication code, embodiments of the present invention may further include determining if one or more required personal attributes match stored personal attributes associated with the stored authentication code assigned to the authorizer. In particular embodiments, the method may further include proceeding with the electronic transaction if the stored authentication code matches the received authentication code and if the one or more required personal attributes match the stored personal attributes associated with the authorizer. The one or more personal attributes may include, for example, name, age, residence, citizenship, profession, social security number, personal identification number, status of professional license, assigned authority and combinations thereof.

Likewise, particular embodiments of the present invention may include requesting from the third party authenticator personal information associated with the authentication code and receiving personal information associated with the authentication code if the received authentication code matches the stored authentication code. However, the third party authenticator may require permission from the authorizer before releasing personal information about the authorizer during an authentication process. Therefore, particular methods may further include requesting authorization from the authorizer to request the personal information from the third party authenticator, receiving authorization from the authorizer to request the personal information and communicating the authorization to request the personal information to the third party authenticator.

Embodiments of the present invention further include computer program products that include computer useable medium having computer usable code for authenticating an electronic transaction that is conducted over an electronic communications link with a user device of a transaction authorizer. The computer program product includes computer useable program code for performing the method steps of embodiments of the present invention. Such code may include, for example, computer useable program code for establishing the electronic communications link with the user device of the authorizer, computer useable program code for receiving an authentication code from an authorizer RFID over the electronic communication link with the authorizer user device and computer useable program code for determining if the received authentication code matches a stored authentication code assigned to the authorizer.

Embodiments of the present invention further include systems for authenticating an electronic transaction, the electronic transaction conducted over an electronic communications link with a user device of a transaction authorizer. Particular embodiments of such systems include one or more processors coupled directly or indirectly to one or more memory devices, input/output devices and a communication device, the communications device adapted for establishing the communications link with the user device of the transaction authorizer, receiving authorization to proceed with the electronic transaction from the authorizer user device and receiving an authentication code from an authorizer RFID over the communications link.

Additionally, the particular embodiment may include an authentication data structure stored in the one or more memory devices and accessible by the one or more processors, wherein the authentication data structure includes data selected from a stored authentication code of the authorizer, one or more stored personal attributes of the authorizer, one of more identity parameters of the authorizer or combinations thereof.

A transaction manager may also be included in the system of the particular embodiment, having a logical structure to provide instructions to the one or more processors for authenticating the electronic transaction including determining if the received authentication code matches the stored authentication code of the authorizer stored in the authentication data structure and proceeding with the electronic transaction if the stored authentication code matches the received authentication code.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of an exemplary system for authenticating an electronic transaction conducted over an electronic communications link with a user device.

FIG. 2 is a flow chart of an exemplary method for authenticating an electronic transaction in accordance with the present invention.

FIG. 3 is a flow chart of an exemplary method for authenticating an electronic transaction by a third party authenticator.

FIG. 4 is a flow chart of another exemplary method for authenticating an electronic transaction that includes authentication of a personal attribute.

### DETAILED DESCRIPTION OF PREFERRED EMBODIMENTS

The present invention includes methods, computer program products and systems for authenticating electronic transactions that are conducted over an electronic communications link established with a user device of an authorizer. Individuals, groups of individuals, businesses and government organizations are increasing their use and dependency on electronic transactions because of the speed, efficiency and cost reductions that such transactions provide. However, because such transactions are not face-to-face and are often conducted between parties that don't know each other, there is an increasing need to ensure that all the parties involved in the electronic transaction are who or what they claim to be. Authentication seeks to prove that a party to an electronic transaction is who the party claims to be and/or possesses claimed attributes to the satisfaction of other parties involved in the electronic transaction.

In a particular embodiment of the present invention, a method for authenticating an electronic transaction that takes place over an electronic communications link with a user device includes establishing the electronic communications link with the user device of an authorizer for the electronic transaction. The authorizer is a party to the electronic transaction that provides authorization for the electronic transaction to proceed. For example, the authorizer to a business transaction taking place over the Internet may be a consumer who is purchasing goods from a website of a business. Until the user device of the authorizer communicates the authorization to proceed with the electronic business transaction by, for example, providing a credit card number for payment of the goods, the electronic business transaction will not proceed.

However, the present invention should not be viewed to being limited solely to business transactions or even to business transactions that include a purchase. The electronic transaction may be any type of transaction taking place electronically over an electronic communications link with the user device of the authorizer. Another example of such an electronic transaction may include a transaction for transferring confidential information with the authorizer. For example, a physician's office or medical lab may provide lab results to a patient who has established an electronic communications link with a user device to the office or lab for the purpose of receiving medical lab results. The lab will not provide the confidential information until the patient authorizes the lab to provide the information. Another example may include a physician establishing an electronic communications link with a user device to a pharmacist to provide a prescription for a patient. By calling in the prescription, the physician is authorizing the pharmacist to fill the prescription. Therefore, there are many electronic transactions in which the present invention may be included and such electronic transactions are not limited merely to business or purchasing scenarios.

Any suitable means for establishing the electronic communications link with the user device are suitable for particular embodiments of the present invention. For example, an electronic communications link with the user device may be established over the Internet, over an intranet, over a wide area network or local area network, over a telephone system or combinations thereof. Telephone systems include all the different varieties such as, for example, cellular systems, mobile systems, satellite systems or combinations thereof.

Similarly, any suitable electronic device may be used as the user device to establish the electronic communications link. Examples of suitable user devices include telephones, personal computers, mainframe computers, servers, laptop computers, other devices having processors and memory, personal digital assistants or combinations thereof. Similar devices may also be used for the other parties involved with the electronic transaction. The terms “user device of the authorizer” or “authorizer user device” is used herein to describe an electronic device that is in the possession and control of the authorizer and is not, for example, in the possession and control of the other party to the electronic transaction or a merchant at a point of sale, such as in a store.

Particular method embodiments of the present invention may further include the step of receiving authorization to proceed with the electronic transaction from the authorizer user device. Such authorization, as discussed above, includes the authorizer providing information or a statement to proceed with the electronic transaction. If the electronic transaction is an electronic business purchasing transaction, for example, then such authorization may be in the form of receiving from the authorizer user device account identification for payment collection. Such account identification may include, for example, a credit card number, debit card number, account number, bank account number or combinations thereof. Authorization for a non-business electronic transaction may include, as from the examples above, a physician providing a prescription to a pharmacist to be filled or a patient authorizing release of medical lab information to the patient over the electronic communications link with the user device of the authorizer.

The party of the electronic transaction that receives or will receive the authorization to proceed with the electronic transaction from the authorizer may demand assurances that the party authorizing the electronic transaction is indeed the same party as the party claims to be and/or that the authorizer possesses certain defined personal attributes. To accomplish this, a request is made to the authorizer user device to provide information to authenticate the authorizer; that is, to provide information that establishes the identity of the authorizer. Therefore, particular embodiments of the present invention may further include the step of receiving an authentication code from an authorizer RFID over the electronic communications link with the authorizer user device.

Similar to barcode and voice data entry, RFID (Radio Frequency Identification) technology is a subset of the contactless information acquisition technology. A typical RFID device includes an antenna, a transceiver and a transponder, or RFID tag, which is electronically programmed with unique information such as, for example, the authentication code. The antenna and transceiver are coupled as the “reader” of the RFID tag. The reader emits radio waves so that when the RFID tag, which also typically includes an antenna, passes through the zone of the emitted radio waves, it detects the activation signal of the reader. The reader receives and decodes the data, such as the authentication code, encoded in the integrated circuit of the RFID tag transponder.

RFID technology is well known to those having ordinary skill in the art and is a rapidly changing and developing technology. The RF tag may be battery operated or may operate without a battery. U.S. Pat. No. 6,572,015, issued to Norton, discloses a smart card utilizing RFID technology having wireless communication capability and is hereby incorporated fully by reference.

RF tags communicate wirelessly with readers using one of several known communication protocols. One popular wireless communication protocol is Bluetooth, which provides a specification for short distance wireless radio frequency (RF) communication applications. Bluetooth operates in a multi-user environment to allow wireless communication between wireless communication devices within a specific radius of each other. An example of a wireless smart card utilizing Bluetooth technology may be found in the U.S. Patent Publication No. 2003-0172028 of Abell, et al., which is hereby fully incorporated by reference.

Current embodiments of RFID tags provide end user capability to easily and inexpensively utilize printers for encoding and printing RFID labels that can be read by RFID readers. With such ease and low cost, one-time use RF tags may be provided for authentication purposes to an expected electronic transaction. For example, a physician may provide a patient with such a one-time use tag to authenticate the identity of the user when the user establishes an electronic communications link with the physician's office or a medical lab to obtain the patient's confidential lab results.

RFID products and technologies are available, for example, from ScanLynx Technologies with corporate offices in Florida. Any RFID device that stores an authentication code in an RFID tag that can be read and recovered by an RFID reader is suitable for use with the present invention.

The authentication code received over the electronic communications link with the authorizer user device may be any string of one or more numbers, symbols, letters, spaces or combinations thereof. The code may be as simple as a name or other word or as complex as an encrypted string of numbers, symbols and letters. Whatever form the authentication code takes, the authentication code is assigned to a particular authorizer so that the authorizer may be authenticated whenever the assigned code is presented for authentication of the authorizer and an electronic transaction.

The authorizer provides for sending the authentication code over the electronic communications link with the authorizer user device by placing the RF tag in proximity to the RF tag reader. The reader collects the authentication code from the RF tag of the authorizer and may transmit the data to the authorizer user device. The authorizer user device may then transmit the authentication code over the electronic communications link. Particular embodiments of the present invention may further include the step of receiving the authentication code from the authorizer RFID over the electronic communication link with the authorizer user device.

In particular embodiments of the present invention, the authentication code recovered from the RF tag by the reader is encrypted to protect the authentication code from theft and unlawful or unauthorized use. In those embodiments, an exemplary method may include the step of decrypting the authentication code received from the RF tag of the authorizer over the communications link with the authorizer user device.

After receiving the authentication code, embodiments of the present invention may further include the step of determining if the received authentication code matches the stored authentication code assigned to the authorizer. If the stored authentication code assigned to the authorizer matches the received authentication code, then the identity of the authorizer may be authenticated. When the authentication code is received, the code may be checked with data stored in a database or other memory device or memory system. For example, the authorizer provides the authentication code and a name or other identity parameter that must be authenticated as belonging to the authorizer. The authenticator then looks up the provided authentication code in the database or other data structure and reads the name or other identity parameter associated with that authentication code. If the stored identity parameter matches the identity parameter given by the authorizer, then the identify of the authorizer may be authenticated. Alternatively, of course, the authenticator could search the database for the identity parameter provided by the authorizer and retrieve the stored authentication code associated with that identity parameter. Then, if the authentication code provided by the authorizer matches the stored authentication code, the identity of the authorizer may be authenticated. The identity parameter may be any suitable identity data that may be associated with the authentication code including, for example, a name, employee number, credit card number, debit card number, address, license number, social security number and similar identity data or combinations thereof.

It should be noted, however, that additional data associated with the authentication code other than just the name of the authorizer may be stored within the database or other memory device or memory system. Other data relating to certain personal attributes and associated with the authentication code and therefore, with the authorizer, may be stored, such as, for example, age, residence, citizenship, profession, social security number, personal identification number and combinations thereof. Other personal attributes that may be stored may include the status of professional licenses held, such as the status of a medical license. Likewise, an assigned authority may be stored as a personal attribute such as, for example, authorization granted by a business for the authorizer to proceed with an electronic transaction only if the total value of the transaction is less than a set amount.

Therefore, the authorizer of the electronic transaction may seek authentication to assure the other party that the authorizer is a particular person (identity) and/or that the authorizer has one or more certain defined personal attributes that are required for the electronic transaction to proceed.

For example, an authorizer of an electronic transaction may seek access to an adults-only Website that requires those admitted to be of a minimum age. If the authentication code allows the authenticator to determine the age of the authorizer by looking it up in the database, then an age authentication may be provided. Likewise, a pharmacist may refuse to accept a prescription for filling from a physician until the physician's possession of a valid medical license is authenticated.

Therefore, particular methods of the present invention may include the step of determining if one or more required personal attributes match stored personal attributes associated with the stored authentication code assigned to the authorizer. An additional step may include proceeding with the electronic transaction if the stored authentication code matches the received authentication code and if the one or more required personal attributes match the stored personal attributes associated with the stored authentication code assigned to the authorizer.

The authenticator may be a third party authenticator. For example, if an authorizer authorizes an electronic transaction over the Internet by providing a credit card number to complete the transaction, the merchant will accept the credit card number as authorization to proceed but may also require authentication of the authorizer as being the possessor of the credit card. The authorizer may then send the authentication code to the merchant by passing the credit card that contains an RF tag past an RF reader. According to particular embodiments of the present invention, the merchant receives the authentication code from the authorizer RFID. The merchant then contacts the third party authenticator that would typically be the card-issuing institution, provides the received authentication code and the credit card number to the card-issuing institution, and receives confirmation that the credit card number is authenticated because the received authentication number matches the stored authentication number associated with that credit card number.

Therefore, particular embodiments of the present invention may further include the steps of establishing an electronic communications link with a third party authenticator and sending the received authentication code and an identity parameter associated with the authorizer to the third party authenticator. After the third party authenticator determines whether the received authentication code matches a stored authentication code assigned to the authorizer, particular embodiments of the present invention may continue with a step of receiving confirmation from the third party authenticator that the received authentication code matches the stored authentication code associated with the authorizer.

A third party authenticator may be any entity that stores the authenticator codes, identity parameters and/or other defined personal attributes that are associated with the identity assigned each specific authenticator code. The third party authenticator must also be able to determine whether a received authentication code matches the stored authentication code associated with a given identity parameter. Therefore, for example, a credit card issuing entity could provide authentication for the identity parameters or other personal attributes that are stored in the database and associated with the credit card number even though the electronic transaction does not involve charging anything to the credit card. Likewise, an entity may be set up to issue and/or manage RF tag authentication codes and data associated with the entities assigned the authentication codes so that the entity provides a third party authentication service.

Particular embodiments of the claimed invention may further include requesting from the third party authenticator one or more stored personal attributes associated with the stored authentication code assigned to the authorizer and receiving the requested stored personal attributes. Alternatively, the third party authenticator may be provided with one or more required personal attributes and requested to authenticate that the authorizer possesses these one or more personal attributes. As discussed above, this may be determined by checking for information concerning personal attributes that are stored associated with the authentication code in the database.

So that the third party authenticator is authorized to provide one or more personal attributes associated with the authorizer, embodiments of the present invention may further include receiving authorization from the authorizer to request the one or more stored personal attributes from the third party authenticator and communicating the authorization from the authorizer to the third party authenticator to request the personal information.

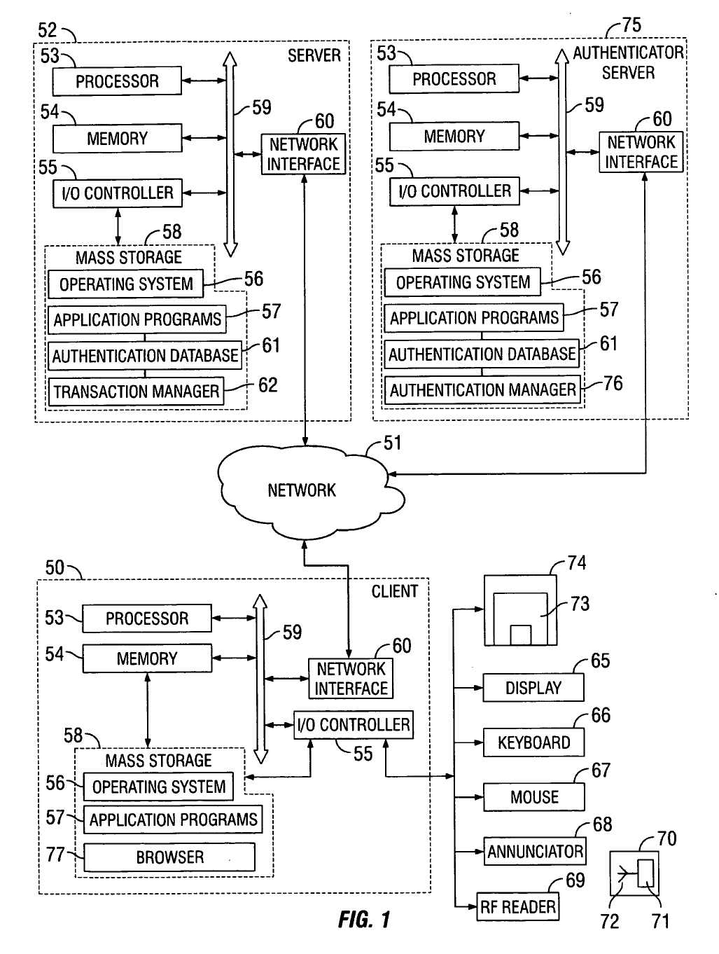

FIG. FIG. 1 is a schematic diagram of an exemplary system for authenticating an electronic transaction conducted over an electronic communications link with a user device. A server 52 is provided in communication with a client user device 50 through a communications network 51. An authenticator server 75 is provided in communication with the server 52 through the network 51. The communications network 51 may include permanent connections, such as wire, coaxial cable or fiber optic cables, or temporary connections made through telephone lines or wireless communications. Personal computers and servers may be represented by a variety of computing devices, such as mainframes, personal computers, personal digital assistants and Internet-connected cellular telephones. The network may include additional servers, routers and other devices not shown. Specifically, the network 51 may include a telephone network, and a global computer communications network, such as the Internet, representing a worldwide collection of networks and gateways that use the TCP/IP suite of protocols to communicate with one another, an intranet, a local area network (LAN), or a wide area network (WAN).

Both of the servers 52, 75 and the client user device 50 include conventional components such as a processor 53, memory 54 (e.g. RAM), a bus 59 that couples the processor 53 and memory 54, a mass storage device 58 (e.g. a magnetic hard disk and/or an optical storage disk) coupled to the processor 53 and memory 54 through an I/O controller 55 and a network interface 60, such as a conventional network interface card. The client further includes conventional input/output devices such as a display 65, a keyboard 66, a mouse 67 and an annunciator 68. Also included with the client user device 50 is an RF reader 69 as an input device that reads data from the FR tag 70. The RF tag 70 further includes a transponder 71 that holds an authentication code that is transmitted through the antenna 72 to the RF reader 69.

The present invention may be implemented in a variety of software environments. A typical operating system 56 may be used to control program execution within the servers 52, 75 and client user device 50. The servers 12, 75 include conventional server software programs such as IBM's Websphere®, for administering the interaction with the client user device 50 and each other. Likewise, the client user device 50 includes a typical browser software program for communicating with the server 52.

It will be appreciated that the present invention may be implemented in software that is stored as executable instructions on a computer readable medium of the servers 52, 75 and client user device 50, such as the mass storage device 58, or in memory 54. Application programs 57 and an operating system program 56 reside on the mass storage device 58 and are loaded into memory 54 for execution. The operating system program 56 manages the resources of the servers 52, 75 and the client user device 50. The application programs 57 generally comprise computer-executable instructions, performing tasks as required by the servers 52, 75 and client user device 50, including database management.

An authentication database 61 residing in the mass storage 58 of the servers 52, 75 stores the authentication codes, associated identity parameters and other defined personal attributes. A transaction manager 61 generally comprises computer-executable instructions and resides on the server 52 to provide instructions to the processors 53 for authenticating and proceeding with the electronic transaction. An authentication manager 76 generally comprises computer-executable instructions and resides on the authenticator server 75 to provide instructions to the processors 53 when the authenticator server 75 is used as a third party authenticator. A browser 77 may also reside as an application program 57 on the client 50 to provide user interface with the server 52, such as a website hosted by the server 52. The application programs 61 residing on the client 50 may also include computer-executable instructions for interfacing with the transaction manager 62 of the server 52 and with the RF reader 69.

The exemplary system shown in FIG. 1 does not imply architectural limitations. For example, the client user device may be a notebook computer, a hand held computer, a personal digital assistant, another server, a cellular or mobile telephone or other electronic device having memory and processors and capable of communicating with a server over a network. Likewise, the server may be replaced with similar electronic devices as the client. The methods of the present invention are performed by processors using computer implemented instructions that may be located in a memory.

It should be recognized therefore, that embodiments of the present invention may take the form of an entirely hardware embodiment, an entirely software embodiment and/or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

While inventive embodiments of methods are demonstrated in the following flow charts of the figures that follow, it should be realized that the demonstrated methods are exemplary methods provided by the present invention and may be implemented using computer code and/or a suitable system.

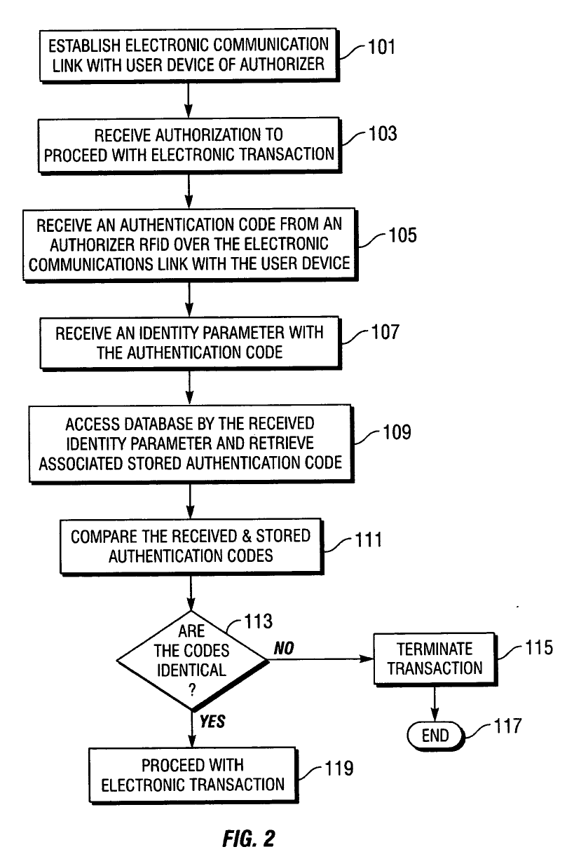

FIG. 2 is a flow chart of an exemplary method for authenticating an electronic transaction in accordance with the present invention. The method begins with state 101, establishing an electronic communication link with a user device of an authenticator participating in the electronic transaction. In state 103, receiving authorization from the authenticator user device to proceed with the electronic transaction. In state 105, the exemplary method continues with the step of receiving an authentication code from an RFID over the electronic communication link with the user device. In state 107, receive an identify parameter with the authentication code.

In state 109, access the database by the received identity parameter and retrieve the associated stored authentication code. In state 111, compare the received and the stored authentication codes. If, in state 113, the codes are not identical, then in state 115, the transaction is terminated and in state 117, the method ends. If, in state 113, the codes are identical, then in state 119, the authorizer is authenticated and the electronic transaction proceeds.

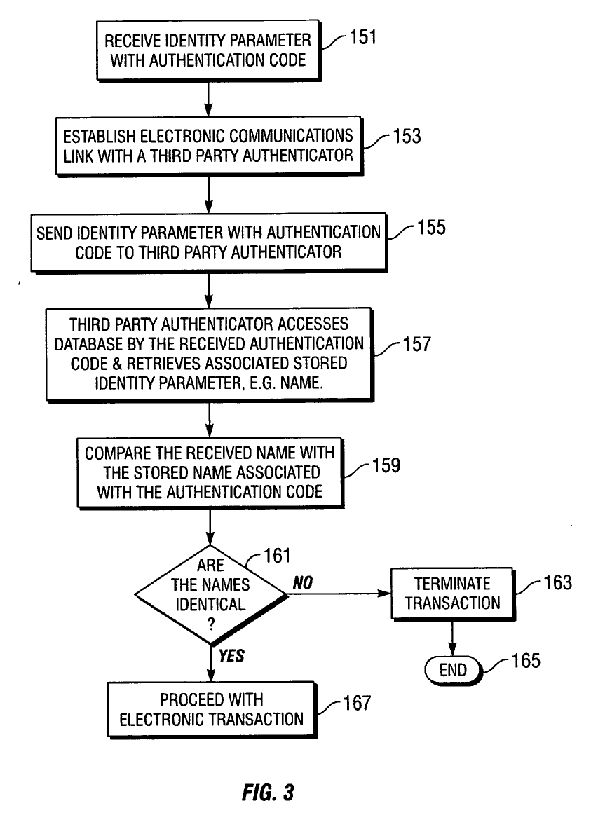

FIG. 3 is a flow chart of an exemplary method for authenticating an electronic transaction by a third party authenticator. This exemplary method is a variation of the method shown in FIG. 2. In state 151, having already established the electronic communication linked and received authorization to proceed, the identity parameter and authentication code is received. In state 153, the exemplary method includes establishing an electronic communications link with a third party authenticator. In state 155, the identity parameter and authentication code is sent to the third party authenticator. In state 157, the third party authenticator accesses the database by the received authentication code and retrieves the associated stored identity parameter, e.g., the name of the authorizer. In state 159, the received name is compared to the stored name associated with the authentication code. If, in state 161, the names are not identical, then in state 163, the transaction is terminated and in state 165, the method ends. If, in state 161, the names are identical, then in state 167, the authorizer is authenticated and the electronic transaction proceeds.

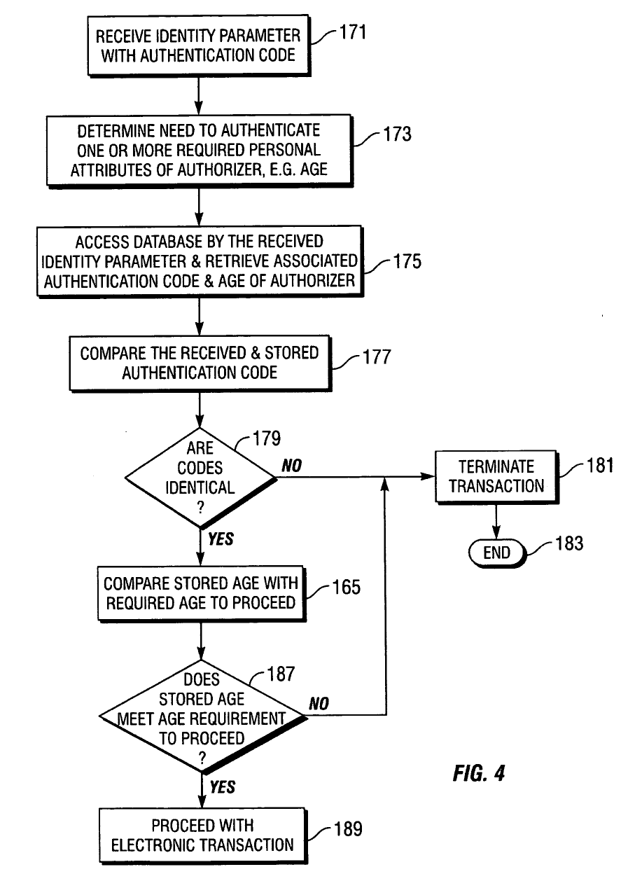

FIG. 4 is a flow chart of another exemplary method for authenticating an electronic transaction that includes authentication of a personal attribute. This exemplary method is a variation of the method shown in FIG. 2. In state 171, having already established the electronic communication linked and received authorization to proceed, the identity parameter and authentication code is received. In state 173, a determination is made for the need to authenticate one or more required personal attributes of the authorizer, e.g., age, before the electronic transaction may proceed. In state 175, the database is accessed by the received identity parameter for retrieving the associated authentication code and the age of the authorizer. In state 177, the received and stored authentication codes are compared.

If, in state 177, the authentication codes are not the same, then in state 181, the transaction is terminated and in state 183, the method ends. If, in state 177, the authentication codes are the same, then in state 185, the method proceeds with comparing the stored age with the required age to proceed. If, in state 187, the stored age does not meet the age requirement to proceed with the transaction, then the method proceeds to state 181 as discussed above. If, in state 177, the stored age does not meet the age requirement to proceed with the transaction, then in state 189, the electronic transaction proceeds.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method for authenticating an electronic transaction, the electronic transaction conducted over an electronic communications link with a user device of a transaction authorizer, the method comprising:
establishing the electronic communications link with the user device of the authorizer;
receiving authorization to proceed with the electronic transaction from the authorizer user device;
receiving an authentication code from an authorizer RFID over the electronic communication link with the authorizer user device;
determining if the received authentication code matches a stored authentication code assigned to the authorizer; and
proceeding with the electronic transaction if the stored authentication code matches the received authentication code.

2. The method of claim 1, further comprising:
decrypting the authentication code received from the authorizer RFID.

3. The method of claim 1, further comprising:
determining if one or more required personal attributes match stored personal attributes associated with the stored authentication code assigned to the authorizer.

4. The method of claim 3, further comprising:
proceeding with the electronic transaction if the stored authentication code matches the received authentication code and if the one or more required personal attributes match the stored personal attributes associated with the stored authentication code assigned to the authorizer.

5. The method of claim 3, wherein the one or more personal attributes are selected from name, age, residence, citizenship, profession, social security number, personal identification number, status of professional license, assigned authority and combinations thereof.

6. The method of claim 1, wherein the step of determining if the received authentication code matches a stored authentication code further comprises:
establishing an electronic communications link with a third party authenticator;
sending the received authentication code and an identity parameter of the authorizer to the third party authenticator; and
receiving confirmation from the third party authenticator that the received authentication code matches the stored authentication code associated with the authorizer.

7. The method of claim 6, further comprising:
requesting from the third party authenticator personal information associated with the authentication code; and
receiving personal information associated with the authentication code if the received authentication code matches the stored authentication code.

8. The method of claim 7, further comprising:
requesting authorization from the authorizer to request the personal information from the third party authenticator;
receiving authorization from the authorizer to request the personal information; and
communicating the authorization to request the personal information to the third party authenticator.

9. The method of claim 1, wherein the electronic transaction is a business transaction.

10. The method of claim 9, wherein the electronic business transaction is a purchasing transaction, the step of receiving authorization to proceed with the electronic transaction further comprises:
receiving an account identification for payment collection from the authorizer.

11. The method of claim 10, wherein the account identification is selected from a credit card number, a bank account number, a debit card number, an account number or combinations thereof.

12. The method of claim 1, wherein the electronic transaction is a confidential information transfer transaction, the method further comprises:
transferring confidential information with the authorizer.

13. The method of claim 1, wherein the electronic communications link is established over an intranet, the Internet, a wide area network, a telephone network or combinations thereof.

14. The method of claim 1, wherein the electronic communications link with the authorizer is established by the authorizer utilizing an electronic device selected from a telephone, a personal computer, a personal digital assistant, a laptop computer or combinations thereof.

15. A computer program product comprising a computer useable medium having computer usable code for authenticating an electronic transaction, the electronic transaction conducted over an electronic communications link with a user device of a transaction authorizer, the computer product comprising:
computer useable program code for establishing the electronic communications link with the user device of the authorizer;
computer useable program code for receiving authorization to proceed with the electronic transaction from the authorizer user device;
computer useable program code for receiving an authentication code from an authorizer RFID over the electronic communication link with the authorizer user device;
computer useable program code for determining if the received authentication code matches a stored authentication code assigned to the authorizer; and
computer useable program code for proceeding with the electronic transaction if the stored authentication code matches the received authentication code.

16. The computer program product of claim 15, further comprising:
computer useable program code for determining if one or more required personal attributes match stored personal attributes associated with the stored authentication code assigned to the authorizer; and
computer useable program code for proceeding with the electronic transaction if the stored authentication code matches the received authentication code and if the one or more required personal attributes match the stored personal attributes associated with the stored authentication code assigned to the authorizer.

17. The computer program product of claim 15, further comprising:
computer useable program code for establishing an electronic communications link with a third party authenticator;
computer useable program code for sending the received authentication code and an identity parameter of the authorizer to the third party authenticator; and
computer useable program code for receiving confirmation from the third party authenticator that the received authentication code matches the stored authentication code associated with the authorizer.

18. The computer program product of claim 17, further comprising:
computer useable program code for requesting from the third party authenticator personal information associated with the authentication code; and
computer useable program code for receiving personal information associated with the authentication code if the received authentication code matches the stored authentication code.

19. A system for authenticating an electronic transaction, the electronic transaction conducted over an electronic communications link with a user device of a transaction authorizer, the system comprising:
one or more processors coupled directly or indirectly to one or more memory devices, input/output devices and a communication device, the communications device adapted for establishing the communications link with the user device of the transaction authorizer, receiving authorization to proceed with the electronic transaction from the authorizer user device and receiving an authentication code from an authorizer RFID over the communications link;
an authentication data structure stored in the one or more memory devices and accessible by the one or more processors, wherein the authentication data structure includes data selected from a stored authentication code of the authorizer, one or more stored personal attributes of the authorizer, one of more identity parameters of the authorizer or combinations thereof; and
a transaction manager having a logical structure to provide instructions to the one or more processors for authenticating the electronic transaction including determining if the received authentication code matches the stored authentication code of the authorizer stored in the authentication data structure and proceeding with the electronic transaction if the stored authentication code matches the received authentication code.

20. The system of claim 19, further comprising:
the transaction manager further providing instructions to the one or more processors for determining if one or more required personal attributes match stored personal attributes associated with the stored authentication code assigned to the authorizer; and
proceeding with the electronic transaction if the stored authentication code matches the received authentication code and if the one or more required personal attributes match the stored personal attributes associated with the stored authentication code assigned to the authorizer.
